(19) United States
(12) Patent Application Publication
(10) Pub. No.: US 2026/0267897 A1
(43) Pub. Date: Sep. 10, 2026

(54) AUTOMATED GENERATION OF DATA SOURCE DESCRIPTIONS FOR AGENTIC WORKFLOWS

(71) Applicant: NVIDIA Corporation, Santa Clara, CA (US)

(72) Inventors: Sushilkumar Prabu KOUNDINYAN, Bordentown, NJ (US); Jean-François PUGET, Saint Raphael (FR)

(73) Assignee: NVIDIA Corporation, Santa Clara, CA (US)

(21) Appl. No.: 19/304,737

(22) Filed: Aug. 20, 2025

Related U.S. Application Data
(60) Provisional application No. 63/768,550, filed on Mar. 7, 2025.

(51) Int. Cl. G06F 16/34; G06F 16/334

(52) U.S. Cl. CPC G06F 16/345; G06F 16/3347

(57) ABSTRACT

Various examples, systems, and methods are disclosed relating to automated generation of data source descriptions for agentic workflows. A system can query a data collection with a zero-vector to retrieve a subset of data from the data collection. A system can generate, using a machine learning model, a summary of the data collection based at least on the subset of data.

### CROSS-REFERENCE TO RELATED APPLICATIONS

This application claims the benefit of U.S. Provisional Application No. 63/768,550, filed on Mar. 7, 2025, the contents of which are hereby incorporated by reference in their entirety.

### BACKGROUND

Machine learning (ML) models, such as Retrieval-Augmented Generation (RAG) models, can retrieve contextual information from external data sources not included in their original training data. This allows them to generate up-to-date responses to a given prompt. Some systems retrieve contextual information from a range of data sources by relying on manually generated data set descriptions. These systems require time-consuming manual intervention, especially for large data collections that often contain heterogeneous information. Systems that rely on user-generated query vectors can introduce user biases, potentially overlooking the collection's broader context and inaccurately describing multi-lingual collections. Other systems retrieve contextual information from a range of data sources using iterative, multi-step processes that are computationally intensive and may introduce biases that can reduce the performance of the machine learning models that rely on such descriptions.

### SUMMARY

Implementations of the present disclosure relate to automated generation of data source descriptions for agentic workflows. Systems and methods are disclosed that can automate the generation of data source descriptions by querying the data collection with a baseline vector, such as a zero vector, to generate an unbiased representative subset of the collection.

In contrast to conventional systems, such as those described above, the systems and methods herein can generate summaries for the data by extracting key elements from the representative subset and condensing them (e.g., using a map-reduce approach) into a single comprehensive sentence. Systems and methods herein can generate data source descriptions with reduced bias, such that corresponding language models that perform retrieval operations on the data sources using the data source descriptions operate with reduced bias.

In some implementations, the techniques described herein relate to one or more processors including processing circuitry to query a data collection with a zero-vector to retrieve a subset of data from the data collection, and generate, using a machine learning model, a summary of the data collection based at least on the subset of data.

In some implementations, the techniques described herein relate to one or more processors, wherein the processing circuitry is to receive one or more prompts, select, using the machine learning model, the data collection based at least on the summary of the data collection and the one or more prompts, generate, using the machine learning model, an answer to the one or more prompts based at least on the selected data collection, and display, via a user interface, the answer to the one or more prompts.

In some implementations, the techniques described herein relate to one or more processors, wherein the processing circuitry is to query a second data collection with a second zero-vector to retrieve a second subset of data from the second data collection, and generate, using the machine learning model, a second summary of the second data collection based at least on the second subset of data.

In some implementations, the techniques described herein relate to one or more processors, wherein the processing circuitry is to determine a threshold based at least on a dimension of the machine learning model, divide the subset of data into a plurality of chunks based at least on a size of the subset of data exceeding the threshold, input a first prompt to the machine learning model to generate a second summary of each chunk of the plurality of chunks to obtain a plurality of summaries, input a second prompt to the machine learning model to condense the plurality of summaries into a third summary, and generate the summary of the data collection based at least on the third summary.

In some implementations, the techniques described herein relate to one or more processors, wherein the processing circuitry is to determine a threshold based on a context limit of the machine learning model, input the subset of data into a tokenizer to determine a number of tokens of the subset of data, divide the subset of data into a plurality of chunks based at least on the number of tokens exceeding the threshold, input a first prompt into the machine learning model to generate a second summary of each chunk of the plurality of chunks to obtain a plurality of summaries, input a second prompt into the machine learning model to condense the plurality of summaries into a third summary, and generate the summary of the data collection based at least on the third summary.

In some implementations, the techniques described herein relate to one or more processors, wherein the summary is a single-sentence summary.

### BRIEF DESCRIPTION OF THE DRAWINGS

The present systems and methods for automated generation of data source descriptions for agentic workflows are described in detail below with reference to the attached drawing figures, wherein:

FIG. 1 is a block diagram of an example agentic workflow system, in accordance with implementing some implementations of the present disclosure;

FIG. 2 is a flow diagram of an example method for generating data source descriptions, in accordance with implementing at least some implementations of the present disclosure.

FIG. 3 is a system-flow diagram of an example function workflow for generating a data source description of a data collection, in accordance with implementing at least some implementations of the present disclosure.

FIG. 4A is a block diagram of an example generative language model system suitable for use in implementing at least some implementations of the present disclosure;

FIG. 4B is a block diagram of an example generative language model that includes a transformer encoder-decoder suitable for use in implementing at least some implementations of the present disclosure;

FIG. 4C is a block diagram of an example generative language model that includes a decoder-only transformer architecture suitable for use in implementing at least some implementations of the present disclosure;

FIG. 5 is a block diagram of an example computing device suitable for use in implementing at least some implementations of the present disclosure; and

FIG. 6 is a block diagram of an example data center suitable for use in implementing at least some implementations of the present disclosure.

### DETAILED DESCRIPTION

Systems and methods are disclosed related to automated generation of data source descriptions for agentic workflows. Some machine learning (ML) models, such as Retrieval-Augmented Generation (RAG) models, can retrieve contextual information from external data sources not included in their original training data. This allows them to generate up-to-date responses to a given prompt.

Some systems retrieve contextual information from a range of data sources by relying on manually generated data set descriptions. These systems require time-consuming manual intervention, especially for large data collections that often contain heterogeneous information. Systems that rely on user-generated query vectors can introduce user biases, potentially overlooking the collection's broader context and inaccurately describing multi-lingual collections. Other systems retrieve contextual information from a range of data sources using iterative, multi-step processes that are computationally intensive and may introduce biases that can reduce the performance of the machine learning models that rely on such descriptions.

Systems and methods in accordance with the present disclosure can automate the generation of data source descriptions by querying the data collection with a baseline vector, such as a zero vector, to generate an unbiased representative subset of the collection. The systems and methods can generate summaries for the data by extracting key elements from the representative subset and condensing them (e.g., using a map-reduce approach) into a single comprehensive sentence. This can provide a clear, factual overview of the complete collection regardless of its size.

For example, the system can receive one or more prompts. The system can initiate a process, e.g., using the RAG model, to answer the one or more prompts using a range of data sources. The system can store or be coupled with (e.g., to retrieve data from) a plurality of data collections. The system can query a respective data collection with a zero-vector to generate a subset of data. The system can generate a summary of the data collection with a ML model such as a large language model (LLM). The summary can be a comprehensive, single-sentence summary describing the associated data collection. The summary may include a plurality of sentences. The system can select (e.g., identify, determine), using the RAG model, the data collection of the plurality of data collections based at least on the summary of the data collection. The system can generate, using the RAG model and/or the LLM, an answer to the one or more prompts based at least on the selected data collection. The system can display, via a user interface, the answer to the one or more prompts.

In some implementations, the system can perform a map-reduce approach based on determining that the subset is too large to process in a single pass. For example, the system can determine a threshold based on a context limit of the ML model. The context limit can be a number of tokens that the model can accept as input for a single pass. The system can input the subset of data into a tokenizer to determine a number of tokens of the subset of data. The system can divide the subset of data into a plurality of chunks based at least on the number of tokens exceeding the threshold. The system can input a first prompt (e.g., a mapping prompt) into the ML model to generate a second summary for each chunk of the plurality of chunks to obtain a plurality of summaries. The system can input a second prompt (e.g., a reducing prompt) into the ML model to condense the plurality of summaries into a third summary. The system can generate the summary of the data collection based at least on the third summary. This summary can be used for selecting, using the RAG model, the appropriate data collection for answering the one more prompts.

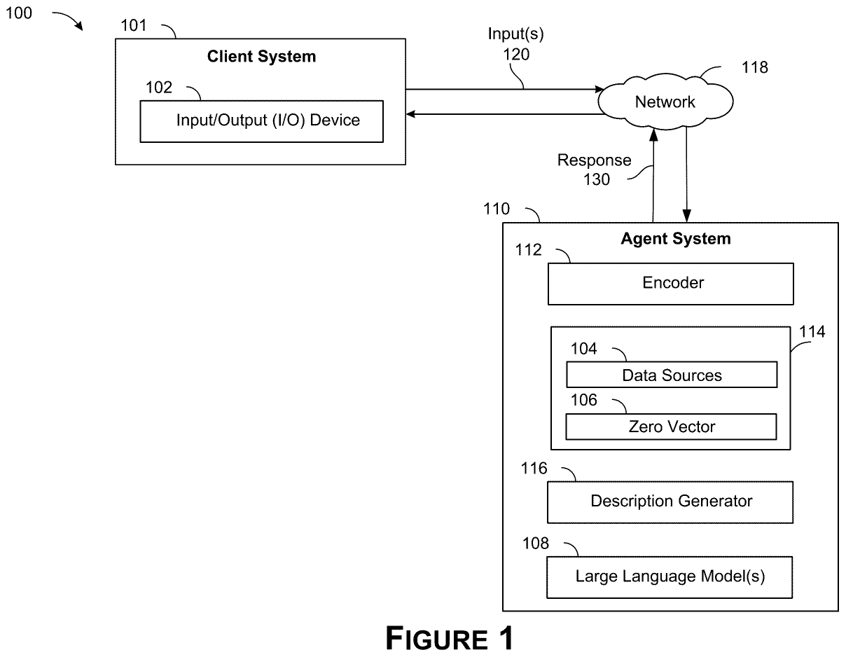

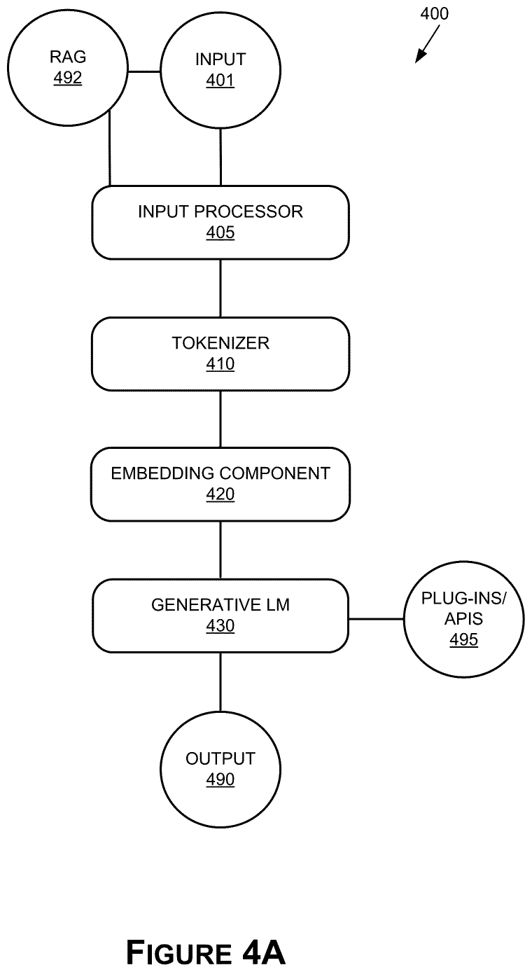

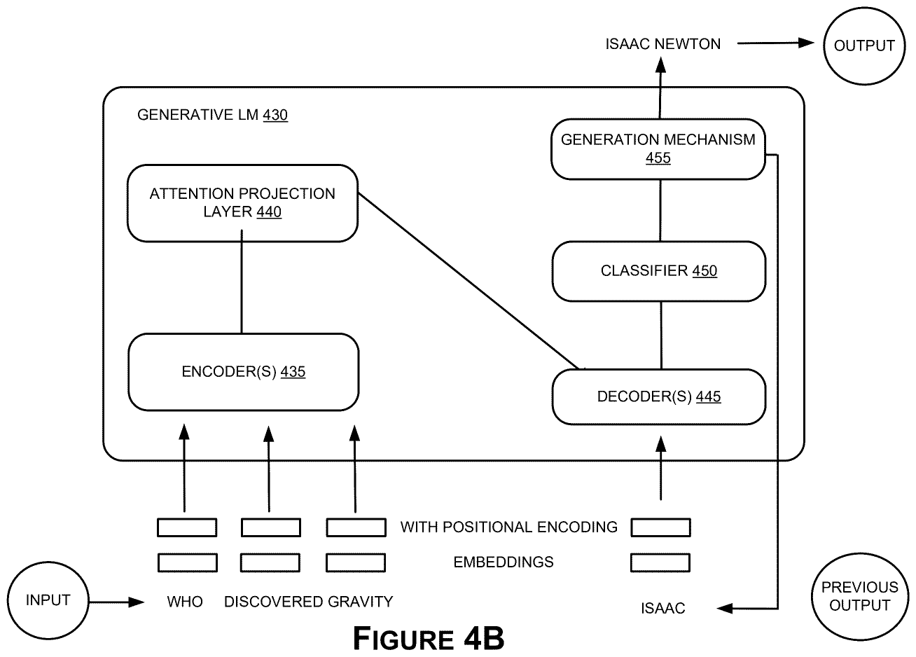

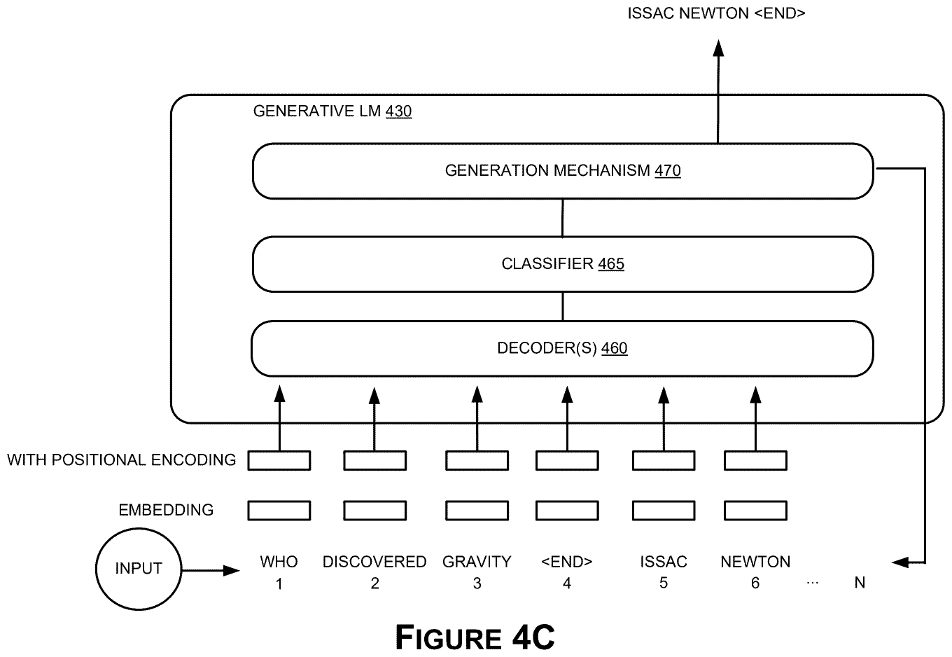

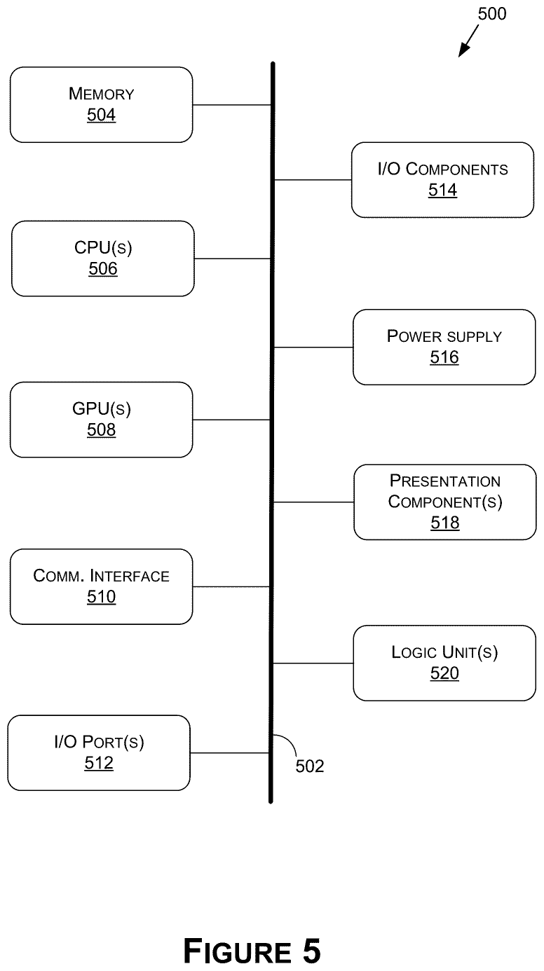

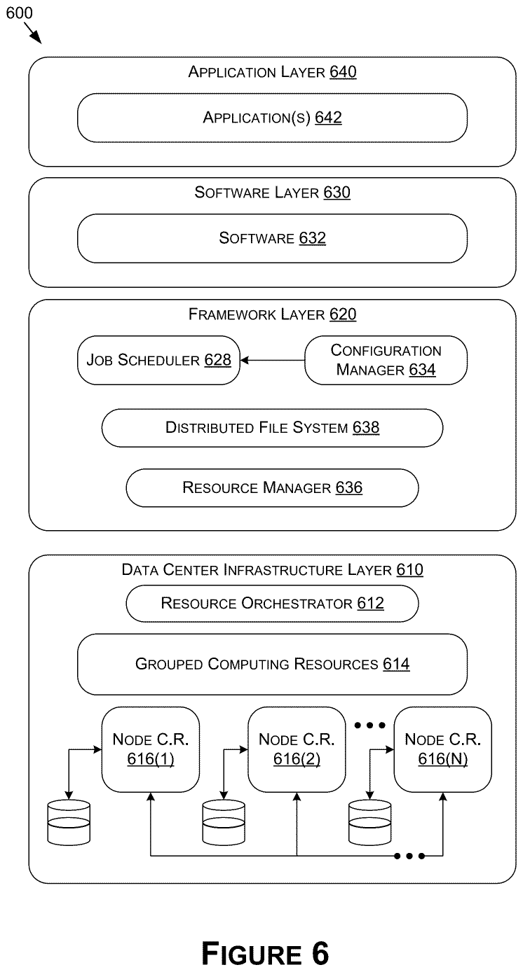

With reference to FIG. 1, FIG. 1 shows an example implementation of an agentic workflow system, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some implementations, the system and methods described herein may be implemented using one or more generative language models (e.g., as described in FIGS. 4A-4C), one or more computing devices or components thereof (e.g., as described in FIG. 5), and/or one or more data centers or components thereof (e.g., as described in FIG. 6).

With reference to FIG. 1, an example computing environment including a system 100 for automated generation of data source descriptions for agentic workflows is shown. FIG. 1 can include a client system 101, which can include one or more input/output device(s) 102. The client system 101 can include any type of device that is capable of communicating via a network 118, including but not limited to smartphones, laptop or mobile computers, personal computers, servers, cloud computing systems, or other types of computing systems that can generate or otherwise provide one or more inputs 120 to at least one agent system 110. The client system 101 can include one or more communications interfaces that enable transmission of one or more network packets via the network 118 to one or more external computing systems, which can include the agent system 110.

In one example, the client system 101 can include input/output devices 102 that receive user input. The user input can include text representative of a query and/or prompt. The text can be processed audio or speech, written text, images, structured data, or any other form of input data. In some implementations, additional or alternative input types may be used, such as audio, video, images, 3D design files (e.g., CAD or universal scene descriptor (USD) files), etc. The input/output devices 102 can include touchscreen interfaces, display devices, a mouse, a keyboard, game controllers, haptic feedback devices, general purpose input devices, or other types of devices capable of providing input to generate one or more inputs 120. The input/output devices 102 of the client system 101 can include one or more display devices, audio output devices, or other output interfaces that provide a response 130 (e.g., output data) produced via a large language model 108 executed by the agent system 110. For example, the input/output devices 102 of the client system 101 can include a display device capable of presenting notifications, messages, or output prompts of the response 130, according to the techniques described herein.

The system 100 is shown as including at least one network 118. The network 118 can include computer networks such as the Internet, local, wide, metro, or other area networks, intranets, satellite networks, other computer networks such as voice or data mobile phone communication networks, and combinations thereof. The encoder 112 of the agent system 110 can communicate via the network 118, for instance with the client system 101. The network 118 can be any form of computer network that can relay information between the agent system 110, the client system 101, and one or more information sources, such as web servers, external databases, or external computing systems, amongst others.

In some implementations, the network 118 can include the Internet and/or other types of data networks, such as a local area network (LAN), a wide area network (WAN), a cellular network, a satellite network, and/or other types of data networks. The network 118 can also include any number of computing devices (e.g., computers, servers, routers, network switches, etc.) that are configured to receive and/or transmit data within the network 118. The network 118 can further include any number of hardwired and/or wireless connections.

The system 100 is shown as including at least one agent system 110, which can be in communication with the client system 101 via the network 118. The agent system 110 can include one or more processors, circuits, memory, and/or computing devices/systems that can perform the various techniques described herein. The agent system 110 described herein can be implemented, for example, in a cloud computing environment, which can maintain and execute one or more large language models 108. As shown, the agent system 110 can include an encoder 112, memory 114 which can include data sources 104 and one or more embeddings such as zero vector 106, description generator 116, and one or more large language models 108.

Referring further to FIG. 1, the system 100 can include or be coupled with one or more data sources 104. The data sources 104 can include a plurality of data collections. A data collection can include hundreds, thousands, millions, or more documents, such as research papers, articles, financial documents, and/or other documents. The data collection can include multi-lingual elements. In various implementations, the data sources 104 may be heterogeneous with each other and/or internally, which can make it challenging to extract an unbiased, concise summary.

The system 100 can include an encoder 112 to generate one or more embeddings. For example, the encoder 112 can generate embeddings based on raw input data, including but not limited to data received via the network 118. The encoder 112 can generate the embeddings to be representations of the input data in a reduced dimension space relative to dimensionality of the input data, such as in a latent space or other encoded space. The encoder 112 can generate the embedding as a vector, for example and without limitation. In some implementations, the encoder 112 generates an embedding of a given data source 104. In some implementations, the system 100 receives embeddings of data sources 104.

The system 100 can maintain one or more zero vectors 106. The system 100 can use the zero vectors 106 to query one or more data sources 104, such as to retrieve samples from the data sources 104. The zero vector 106 can be a vector wherein all elements are zero. The zero vector 106 can be a vector having a matching dimension, such as of a size (e.g., length), corresponding to a dimension of the embedding of a given data source 104. The zero vector 106 can be used to perform queries without query semantics. The zero vector 106, when used as input in a model (e.g., RAG model), can act as a neutral element. The zero vector 106 can leverage the inherent structure of the embedding space of the data collection to return a broad, unbiased sample of the collection.

For example, the system 100 can apply the zero vector 106 as a query to a given data source 104 (e.g., where the zero vector 106 is a vector of zeroes having a same dimension as the embedding(s) associated with the given data source 104) to retrieve one or more elements of the data source 104 (e.g., one or more documents of the data source 104) that match the zero vector 106. For example, the system 100 can use the zero vector 106 to retrieve, from the given data source 104, a subset of elements of the given data source 104 near to the zero vector 106 in the embedding space of the embeddings of the given data source 104, such as within a threshold distance from the zero vector 106 and/or up to a threshold number of nearest neighbors to the zero vector 106. As such, the system 100 can retrieve a representative unbiased subset of elements of the given data source 104, which as described herein can be used to more efficiently generate a useful description of the given data source 104.

Referring further to FIG. 1, the system 100 can include a description generator 116. The description generator 116 can include one or more natural language processors, including but not limited to language models and/or LLMs. For example, the description generator 116 can maintain one or more prompts to apply, as a language model, for retrieving information from a data collection.

The description generator 116 can generate one or more data source description of any given data collection of the data sources 104. The description generator 116 can generate the description to include information such as type of content in the data collection, purpose of the information, or data types of the information. For example, the description generator 116 can generate a description of the subset of elements (e.g., for each element of the subset of elements) retrieved, using the zero vector 106, from any given data source 104.

In some implementations, the description generator 116 consolidates descriptions from multiple elements. For example, the description generator 116 can perform a map-reduce operation to summary generation using one or more specifically designed prompts. The one or more prompts can instruct the language model to extract key elements (such as the subject matter, technical terms, and data types) and condense them into a single comprehensive sentence. The description generator 116 can apply a map-reduce algorithm based at least on a number of retrieved documents (e.g., elements of the subset) and/or an amount of data of the retrieved documents exceeding a context limit of the description generator 116. For example, for very large databases, the subset of documents may be proportionally large to be representative of the collection, which may be greater than the context limit of the description generator 116. This summary approach can provide a clear, factual overview of the complete collection, regardless of its size, based on the representative subset.

Referring further to FIG. 1, the system 100 can include one or more large language models 108 for generating a response 130 based on the input 120 and one or more data source descriptions (e.g., generated by description generator 116). One or more large language models 108 can generate a response 130 by first processing the input 120 to understand the specific query or prompt provided by the user. The one or more large language models can leverage data source descriptions generated by the description generator 116, which employs techniques such as the RAG (Retrieval-Augmented Generation) search agent model. The RAG model allows the large language models 108 to retrieve relevant information from vast data collections identified by the description generator 116. By integrating this retrieved data, the models can generate a well-informed and contextually accurate response. The response 130 can thus be a synthesis of the input 120 and the most pertinent information available, which can ensure the output is both relevant and comprehensive.

The response 130 can be provided for display at the computing system that provided the input 120. For example, the response 130 can be provided as input to the client system 101 for display via the input/output device(s) 102. If the input 120 is received via input to the agent system 110, the agent system 110 can provide the response 130 via an output device of the agent system 110.

The agent system 100 can include or be communicatively coupled with the description generator 116. For example, the agent system 110 can communicate instructions to the description generator 116 to generate the one or more data source descriptions. The description generator 116 can include memory 114 such as for storing data sources 104 and the zero vector 106. The description generator 116 can include the one or more large language models 108. The description generator 116 can include one or more large language models that are different from the one or more large language models 108.

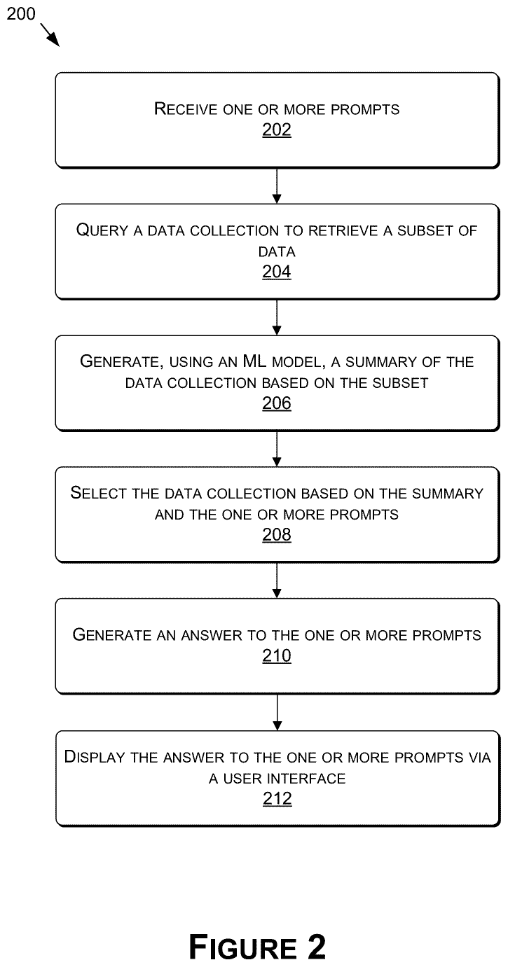

Now referring to FIG. 2, each block of method 200, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method may additionally or alternatively be executed by any one system, or any combination of systems, including, but not limited to, those described herein.

FIG. 2 is a flow diagram showing a method 200 for generating data source descriptions, in accordance with some implementations of the present disclosure.

The method 200, at block 202, can include receiving one or more prompts. The method 200 can involve acquiring the one or more prompts from users or interfaces. The one or more prompts can be queries or tasks to be addressed. The one or more prompts can include various data types such as text, audio, or multimedia that the system's input processing components are designed to handle.

The method 200, at block 204, can include querying a data collection to retrieve a subset of data. The method 200 can include using a zero-vector query to source data collections stored in vector databases. By connecting with embedded vector databases, the method 200 can include retrieving data chunks without introducing user bias, thereby achieving an unbiased selection. This approach can allow for accurate summarization and context integration.

The method 200, at block 206, can include generating a summary of the data collection using an ML model. The method 200 can include processing the retrieved subset with a machine learning model to extricate essential elements such as subject matter and keywords from the data. When subsets exceed model context limits, for example, the process can employ a map-reduce strategy for summarization. The method 200 can include breaking data into manageable chunks that are individually summarized. The method 200 can include consolidating the summaries into a coherent summary of the data collection.

The method 200, at block 208, can include selecting the data collection based on the summary and the prompts. The method 200 can include assessing the synthesized summaries alongside user prompts to pick the most contextually relevant data collection. The method 200 can include utilizing the decision-making components of the ML model to analyze data-to-prompt congruence.

The method 200, at block 210, can include generating an answer to the prompts. The method 200 can include leveraging retrieval-augmented generation techniques to form responses that address the one or more user prompts.

The method 200, at block 212, can include displaying the answer via a user interface. The user interface can be interactive. For example, a user can re-prompt the agent system 110 based at least on the generated answer.

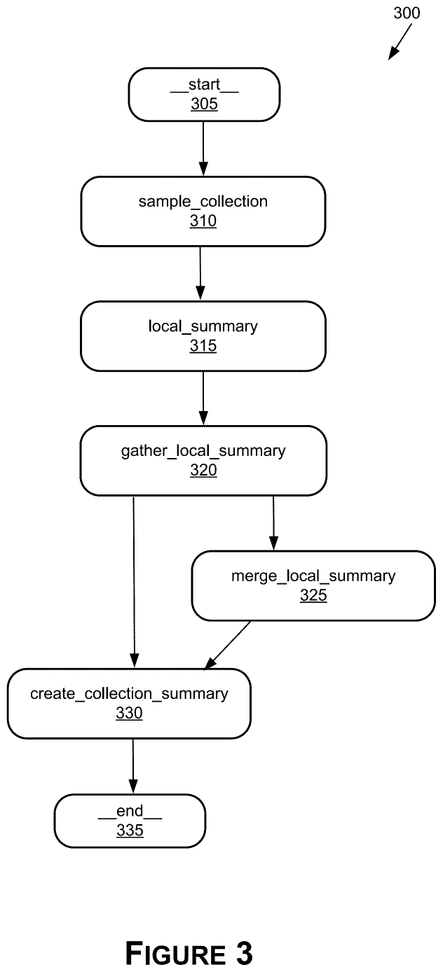

Referring now to FIG. 3, FIG. 3 shows an example implementation of a function workflow 300 for generating a data source description of a data collection, in accordance with some implementations of the present disclosure. One or more functions of the workflow 300 can operate to perform one or more functions associated with the system 100 of FIG. 1. One or more functions of the workflow 300 can perform one or more steps of the method 200 in accordance with FIG. 2.

The workflow 300 at block 305 can include a _start_function to initiate description generation.

The workflow 300 at block 310 can include a sample_collection function for sampling a data collection. The agent can retrieve a representative subset of documents from a data source using the sample_ collection function (block 310) with an unbiased zero vector query (e.g., zero vector 106). By using this unbiased approach, the agent can retrieve a fair representation of the data collection, capturing diverse and relevant information without bias.

The workflow 300 at block 315 can include a local_summary function for generating a local summary, such as a summary corresponding to a subset of chunks of the data collection. The local_summary function (block 315) can summarize the subset of chunks by generating local summaries that encapsulate information of each chunk, allowing for detailed attention to each portion of the data collection, and maintaining the integrity and granularity of the information.

The workflow 300 at block 320 can include a gather_local_summary function for gathering a plurality of local summaries, such as for a plurality of subsets of chunks of the data collection. This function can collect individual summaries generated by the local_summary function and compile the summaries into a comprehensive overview summary. Aggregating these summaries provides a thorough and encompassing perspective of the entire data collection. This function can combine insights from multiple sources to form a cohesive narrative.

The workflow 300 at block 325 can include a merge_local_summary function for merging one or more summaries of the plurality of local summaries. For example, if the aggregated summaries exceed a predefined LLM context limit, they are merged using the merge_local_summary function (block 325) before proceeding. This merging process helps to ensure that the final summary remains within the operational constraints of the language model. By merging the summaries, the system reduces the complexity and volume of the data while preserving the essential information. This step aims to make the final summary concise, comprehensive, and coherent.

The workflow 300 at block 330 can include a create_collection_summary function to create a final summary representative of the data collection. This function synthesizes the aggregated or merged summaries into a single, coherent sentence that accurately represents the entire data collection.

The workflow 300 at block 335 can include an _end_ function to terminate description generation.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications. In some implementations, systems and methods described herein can be used for any of a variety of language model processes, including data retrieval and/or RAG processes, as well as generating text using information retrieved from the data sources.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### EXAMPLE LANGUAGE MODELS

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types. Various such models can use the unbiased vector-based retrieval operations described with reference to FIGS. 1-3 to facilitate improved language processing.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder (e.g., encoder 112) and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some embodiments of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a VLM, a multi-modal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data such as OpenUSD, etc.), depending on the architecture of the generative LM 430 (e.g., LLM/VLM/MMLM/etc.). In some embodiments, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 492 (which may include one or more RAG models, and/or may be performed using the generative LM 430 itself) may be used to retrieve additional information to be used as part of the input 401 or prompt. RAG may be used to enhance the input to the LLM/VLM/MMLM/etc. with external knowledge, so that answers to specific questions or queries or requests are more relevant—such as in a case where specific knowledge is required. The RAG component 492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 401 may be generated using the query or input to the model (e.g., a question, a request, etc.) in addition to data retrieved using the RAG component 492. In some embodiments, the input processor 405 may analyze the input 401 and communicate with the RAG component 492 (or the RAG component 492 may be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular embodiment.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features—such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some embodiments, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof. One or more components of the computing device 500 can be used to implement any one or more components of the system 100.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### EXAMPLE DATA CENTER

FIG. 6 illustrates an example data center 600 that may be used in at least one embodiments of the present disclosure. The data center 600 may include a data center infrastructure layer 610, a framework layer 620, a software layer 630, and/or an application layer 640. Any one or more layers of the data center 600 can be used to implement any one or more components of the system 100, such as to use one or more data centers 600 to perform unbiased vector-based data sampling and description operations.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising processing circuitry to:
query a data collection with a zero-vector to retrieve a subset of data from the data collection; and
generate, using a machine learning model, a summary of the data collection based at least on the subset of data.

2. The system of claim 1, wherein the processing circuitry is to:
receive one or more prompts;
select, using the machine learning model, the data collection based at least on the summary of the data collection and the one or more prompts;
generate, using the machine learning model, an answer to the one or more prompts based at least on the selected data collection; and
display, via a user interface, the answer to the one or more prompts.

3. The system of claim 1, wherein the processing circuitry is to:
query a second data collection with a second zero-vector to retrieve a second subset of data from the second data collection; and
generate, using the machine learning model, a second summary of the second data collection based at least on the second subset of data.

4. The system of claim 1, wherein the processing circuitry is to:
determine a threshold based at least on a dimension of the machine learning model;
divide the subset of data into a plurality of chunks based at least on a size of the subset of data exceeding the threshold;
input a first prompt to the machine learning model to generate a second summary of each chunk of the plurality of chunks to obtain a plurality of summaries;
input a second prompt to the machine learning model to condense the plurality of summaries into a third summary; and
generate the summary of the data collection based at least on the third summary.

5. The system of claim 1, wherein the processing circuitry is to:
determine a threshold based on a context limit of the machine learning model;
input the subset of data into a tokenizer to determine a number of tokens of the subset of data;
divide the subset of data into a plurality of chunks based at least on the number of tokens exceeding the threshold;
input a first prompt into the machine learning model to generate a second summary of each chunk of the plurality of chunks to obtain a plurality of summaries;
input a second prompt into the machine learning model to condense the plurality of summaries into a third summary; and
generate the summary of the data collection based at least on the third summary.

6. The system of claim 1, wherein the summary is a single-sentence summary.

7. The system of claim 1, wherein the summary is a plurality of sentences.

8. The system of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more large language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

9. A method comprising:
querying a data collection with a zero-vector to retrieve a subset of data; and
generating, using a machine learning model, a summary of the data collection for the one or more prompts based at least on the subset of data.

10. The method of claim 9, further comprising:
receiving one or more prompts;
selecting the data collection based at least on the summary and the one or more prompts;
generating an answer to the one or more prompts; and
displaying the answer to the one or more prompts via a user interface.

11. The method of claim 9, further comprising:
querying a second data collection with a second zero-vector to retrieve a second subset of data from the second data collection; and
generating, using the machine learning model, a second summary of the second data collection based at least on the second subset of data.

12. The method of claim 9, wherein the summary is a single-sentence summary.

13. The method of claim 9, wherein the summary is a plurality of sentences.

14. The method of claim 9, further comprising:
determining a threshold based at least on a dimension of the machine learning model;
dividing the subset of data into a plurality of chunks based at least on a size of the subset of data exceeding the threshold; and
inputting a first prompt to the machine learning model to generate a second summary of each chunk of the plurality of chunks to obtain a plurality of summaries.

15. The method of claim 14, further comprising:
input a second prompt to the machine learning model to condense the plurality of summaries into a third summary; and
generate the summary of the data collection based at least on the third summary.

16. The method of claim 9, further comprising:
determining a threshold based on a context limit of the machine learning model;
inputting the subset of data into a tokenizer to determine a number of tokens of the subset of data;
dividing the subset of data into a plurality of chunks based at least on the number of tokens exceeding the threshold; and
inputting a first prompt into the machine learning model to generate a second summary of each chunk of the plurality of chunks to obtain a plurality of summaries.

17. The method of claim 16, further comprising:
inputting a second prompt into the machine learning model to condense the plurality of summaries into a third summary; and
generating the summary of the data collection based at least on the third summary.

18. A system comprising one or more processors to:
query a data collection with a vector to retrieve a subset of data from the data collection, the vector comprising a plurality of zeros and having a dimension corresponding to a dimension of one or more embeddings associated with the data of the collection; and
generate, using a machine learning model, a summary of the data collection based at least on the subset of data.

19. The system of claim 18, wherein the one or more processors are to:
receive one or more prompts;
select, using the machine learning model, the data collection based at least on the summary of the data collection and the one or more prompts;
generate, using the machine learning model, an answer to the one or more prompts based at least on the selected data collection; and
display, via a user interface, the answer to the one or more prompts.

20. The system of claim 18, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.
